(19) United States
(12) Patent Application Publication
(10) Pub. No.: US 2026/0106857 A1
(43) Pub. Date: Apr. 16, 2026

(54) Methods for name resolution, communication, message processing and corresponding server, client device and relay node

(71) Applicant: ORANGE, Issy-les-Moulineaux (FR)

(72) Inventors: Mohamed BOUCADAIR, Chatillon (FR); Christian JACQUENET, Chatillon (FR)

(21) Appl. No.: 19/116,051

(22) PCT Filed: Sep. 27, 2023
(86) PCT No.: PCT/EP2023/076686

§ 371 Date: Mar. 27, 2025

(30) Foreign Application Priority Data
Sep. 29, 2022 (FR) FR2209937

(51) Int. Cl. H04L 61/4511

(52) U.S. Cl. CPC H04L 61/4511

(57) ABSTRACT

A method for processing a first name resolution request originating from a client device is implemented by a name resolution server. It includes sending, to the client device, a response to the first request including at least one piece of information relating to a so-called recipient server resulting from a resolution of the first request. The method further includes sending, to the client device, a plurality of elements including: at least one address of at least one relay node selected by the name resolution server to which the client device must address all or part of its messages containing data intended for the recipient server; and at least one scrambling instruction to be applied by the client device to the messages before addressing them to the at least one relay node.

### CROSS-REFERENCE TO RELATED APPLICATIONS

This Application is a Section 371 National Stage Application of International Application No. PCT/EP2023/076686, filed Sep. 27, 2023, and published as WO 2024/068722 A1 on Apr. 4, 2024, not in English, which claims priority to and the benefit of French Patent Application No. 2209937, filed Sep. 29, 2022, the contents of which are incorporated herein by reference in their entireties.

### PRIOR ART

The invention belongs to the general field of telecommunications.

It relates more particularly to communications with a domain name resolution server (or DNS, for domain name system) in a telecommunications network, such as for example an IP (Internet Protocol) network.

The DNS system is a fundamental component in the provision of IP services. Indeed, it makes it possible to associate a resource (such as a domain name, a Uniform Resource Identifier (URI), etc.) with one or more IP addresses that allow a device (such as for example a terminal) to access this resource.

By way of example, an IPv4 reachable server publishes, to the DNS system, a DNS “A” record (or RR for resource record), while an IPv6 reachable server publishes a DNS “AAAA” record (or Quad A resource record); an IPv4 and IPv6 reachable server publishes both types of record.

When a device wishes to establish a communication with a server, referred to as “recipient” server, identified by a domain name (or FQDN for fully qualified domain name), the DNS client embedded in the device sends a domain name resolution request (referred to as DNS request) to a server of the DNS system (or DNS server for simplification), specifying the desired type of record (A or AAAA) in the request. A device supporting both IPv4 and IPv6 protocols sends two DNS queries to a DNS server (one indicating an A record, the other indicating an AAAA record).

Upon receipt of this request, the DNS server responds to the device by sending it at least one IP address associated with the domain name to which the request relates if an entry corresponding to this domain name is available. If it does not possess such an entry, the DNS server relays the request to another server in accordance with the DNS hierarchy known to those skilled in the art. The response received from this other server is then relayed by the DNS server that was initially called upon to the device at the origin of the DNS request. The device extracts the one or more IP addresses contained in the response and establishes a communication with the recipient server, typically using one of these IP addresses.

These exchanges between the device and the DNS server (hereinafter referred to as “DNS communications” for simplification) are conventionally implemented in plain text, in a mode called Do53 (or unencrypted DNS). This unencrypted mode allows entities located on the DNS communication path to access sensitive information, for example for profiling purposes. Do53 therefore poses a risk of jeopardizing users' privacy.

In order to improve the level of confidentiality of DNS communications and restrict access to sensitive information carried by these DNS communications only to authorized or agreed entities, many mechanisms have been specified for encrypting DNS communications. Examples of such mechanisms are DNS over DTLS (DoD), DNS over TLS (DOT), DNS over HTTPS (DoH), DNS over QUIC (DoQ), DNS over CoAP (or DoC), etc. However, despite the implementation of such mechanisms, an entity located in the DNS communication path is able to associate the destination address of data packets sent after a DNS exchange with a given server or service using what are known as statistical analysis techniques, and thus obtain potentially sensitive information about users. Indeed, a study carried out by APNIC (Asia Pacific Network Information Centre) dating back to 2019 looked at the information able to be derived from a set of IP addresses contacted by a user equipment. This study shows in particular that the majority of websites have a unique page load fingerprint (PLF); there is therefore a risk of a website that is visited by a user being able to be identified based on the IP addresses targeted by their user equipment. This means that the abovementioned encrypted DNS mechanisms provide limited protection of users' privacy.

### SUMMARY OF THE INVENTION

The invention aims in particular to improve the abovementioned situation by proposing a method for processing a first name resolution request from a client device, this method being implemented by a name resolution server and comprising sending, to the client device, a response to the first request comprising at least one item of information relating to a server, referred to as recipient server, resulting from resolution of the first request. The processing method is noteworthy in that it furthermore comprises sending, to the client device, a plurality of elements comprising:
at least one address of at least one relay node selected by the name resolution server to which the client device has to address all or some of its messages containing data destined for the recipient server; and
at least one scrambling instruction to be applied by the client device to said messages before addressing them to said at least one relay node.

In correlation, the invention also relates to a name resolution server configured to send a response to a first name resolution request from a client device, this response comprising at least one item of information relating to a server, referred to as recipient server, resulting from resolution of the first request. The name resolution server is noteworthy in that it is furthermore configured to send, to the client device, a plurality of elements comprising:
at least one address of at least one relay node selected by the name resolution server to which the client device has to address all or some of its messages containing data destined for the recipient server; and
at least one scrambling instruction to be applied by the client device to said messages before addressing them to said at least one relay node.

The invention also targets a communication method implemented by a client device, comprising receiving, from a name resolution server, a response to a first name resolution request sent by the client device, this response comprising at least one item of information relating to a server, referred to as recipient server, resulting from resolution of the first request. The communication method is noteworthy in that it furthermore comprises:
receiving a plurality of elements, from the name resolution server, comprising:
   at least one address of at least one relay node selected by the name resolution server to which the client device has to address all or some of its messages containing data destined for the recipient server; and
   at least one scrambling instruction to be applied by the client device to said messages before addressing them to said at least one relay node; and
applying said scrambling instruction to said messages.

In correlation, the invention also relates to a client device configured to receive, from a name resolution server, a response to a first name resolution request sent by the client device, this response comprising at least one item of information relating to a server, referred to as recipient server, resulting from resolution of the first request. The client device is noteworthy in that it is furthermore configured to:
receive a plurality of elements, from the name resolution server, comprising:
   at least one address of at least one relay node selected by the name resolution server to which the client device has to address all or some of its messages containing data destined for the recipient server; and
   at least one scrambling instruction to be applied by the client device to said messages before addressing them to said at least one relay node; and
apply said scrambling instruction to said messages.

According to yet another aspect, the invention also targets a method for processing messages implemented by a relay node selected by a name resolution server for a client device and a recipient server, this method comprising:
acquiring at least one item of information relating to at least one scrambling instruction applied by the client device to messages containing data destined for the recipient server before addressing them to the relay node;
upon receipt of at least one scrambled message containing data destined for the recipient server and addressed to the relay node by the client device, removing the scrambling applied by the client device using said acquired at least one item of information; and
transferring said at least one message obtained after removal of the scrambling to the recipient server.

In correlation, the invention also relates to a relay node in a communications network selected by a name resolution server for a client device and a recipient server, this relay node being configured to:
acquire at least one item of information relating to at least one scrambling instruction applied by the client device to messages containing data destined for the recipient server before addressing them to the relay node;
upon receipt of at least one scrambled message containing data destined for the recipient server and addressed to the relay node by the client device, remove the scrambling applied by the client device using said acquired at least one item of information; and
transfer said at least one message obtained after removal of the scrambling to the recipient server.

The invention therefore proposes a solution that makes it possible to prevent equipments close to the client device (from the point of view of the network topology) from accessing sensitive information. The solution is thus particularly applicable at the level of the access network used by a client device (for example public or private WLAN (wireless local area network), mobile network, etc.) by using a plurality of network entities (one or more name resolution servers, one or more relay nodes) to prevent malicious actions that may be implemented during DNS communications, or more generally during communications related to the resolution of resources such as URIs, domain names, etc. These resources are more generally referred to as “names” in the remainder of this document. One preferred but non-limiting application of the invention is when the communications in question are encrypted; there is no limitation attached to the encryption scheme that is then envisaged to transport the messages exchanged during these communications (for example for DNS, DoT, DoD, DoQ, DoH, DoC communications).

Similarly, there is no limitation imposed with regard to the nature of the client device (which may be for example a terminal, a CPE (customer premises equipment), an STB (set top box) decoder, etc.), or to that of the relay node selected by the name resolution server (which may in particular be a server, a router, etc.).

The solution proposed by the invention relies more particularly on the selection, by a trusted name resolution server called upon by the client device when it wishes to access a given service, typically provided by a server, referred to as recipient server, of at least one relay node via which the client device will interact with the recipient server. Multiple relay nodes may advantageously be used during a communication with a recipient server; for example, each relay node is used for a limited period of time. It should also be noted that a name resolution request may give rise to one or more communications with one or more recipient servers. The communications with these various recipient servers may be managed with one or more relay nodes.

More specifically, according to the invention, the client device addresses the messages containing the data that it intends for the recipient server (in other words containing the data that it wishes to send thereto in the context of accessing the service) to a relay node, which then takes responsibility for relaying them to the recipient server. The introduction of a relay node between the client device and the recipient server has the effect of masking the actual recipient (that is to say the recipient server) of the data sent by the client device when it accesses the service, since the address to which the messages are sent is that of the relay node and not that of the recipient server, in accordance with the invention. The address of the recipient server is for its part concealed in the content of the messages addressed to the relay node, for example in a form encrypted by way of an encryption mechanism shared with the relay node. This makes it possible to make the identity of the recipient server inaccessible in the event of messages between the client device and the relay node being intercepted, while at the same time allowing the relay node to relay these messages to the recipient server.

For example, in one particular embodiment, the messages addressed to said at least one relay node comprise, in encrypted form, data destined for the recipient server and an address of the recipient server.

These provisions thus make it difficult, or even impossible, for a malicious entity located between the client device and the relay node to obtain, through statistical analysis of the traffic from the client device and/or by establishing and analyzing a page load fingerprint, information revealing the practices of the user of the client device that are liable to jeopardize their privacy.

Similarly, the introduction of a relay node between the client device and the recipient server makes it possible to mask the actual source of the messages (that is to say the identity of the client device), in the event of these messages being intercepted and inspected by a malicious entity located beyond the relay node (in the client device to recipient server direction).

This difficulty in obtaining sensitive data through statistical analysis of traffic is increased when the use of one (or more) relay nodes is combined with one or more (additional) scrambling actions implemented by the client device (possibly supplemented by scrambling actions implemented by the one or more relay nodes). These scrambling actions are transmitted to the client device by the resolution server in the form of scrambling instructions and may be of various kinds.

For example, in one particular embodiment of the method for processing the first request, said at least one scrambling instruction transmitted by the name resolution server to the client device comprises a padding instruction to pad (or fill) the messages containing data destined for the recipient server before addressing them to said at least one relay node, this instruction comprising at least one padding pattern to be used by the client device to scramble said messages or a technique for generating at least one such padding pattern.

In correlation, in one particular embodiment of the communication method, said at least one scrambling instruction comprises a padding instruction to pad said messages, and the application of said at least one scrambling instruction to said messages comprises padding at least one said message containing data destined for the recipient server and addressed to the relay node using a padding pattern provided in said padding instruction or generated by way of a generation technique provided in said padding instruction.

By way of illustration, a message padding instruction may consist, in the context of a voice communication service based on the exchange of small data packets between the client device and the recipient server, in increasing the length of the data packets sent to the relay node by the client device and destined for the recipient server using a determined padding pattern provided by the name resolution server or generated by the client device using a padding pattern generation technique provided by the name resolution server.

The message padding carried out by the client device makes it possible to normalize the profile of the messages sent by the client device and thus to homogenize the traffic leaving the client device. To reinforce the protection of the data carried by the messages sent to the relay node, as mentioned above, the data, the padding pattern supplementing these data, and the address of the recipient server may be encrypted before being addressed to the relay node. This also makes it possible to guarantee the authenticity and integrity of the messages exchanged between the client device and the relay node, and the information contained in these messages. In one particular embodiment, it may be envisaged to activate the encryption by default for sending this critical information (for example for the scrambling pattern).

Other actions of scrambling the messages before they are sent to the relay node may be envisaged in addition to or as a replacement for the abovementioned actions.

Thus, in another embodiment, said at least one scrambling instruction comprises an instruction for the client device to establish at least one fake connection to and/or via said at least one relay node.

Such a fake connection is established in parallel with the connection used by the client device to transmit the messages destined for the recipient server to the relay node (hereinafter referred to as the “main connection”). It may end at the relay node or be relayed thereby to a dedicated server (that is to say one capable of establishing and managing a fake connection properly and knowingly). The client device may be configured to transmit fake data on this fake connection, that is to say data that are not intended to be “consumed” (that is to say exploited, used) by the relay node and/or by the dedicated server that receives them. Similarly, the fake application data possibly transmitted by the dedicated server are not consumed by the relay and/or by the client device.

In one particular embodiment, the method for processing a first name resolution request or the communication method may furthermore comprise a step of notifying said at least one relay node of at least one item of information relating to said at least one scrambling instruction.

This notifying of the relay node by the name resolution server or by the client device allows the relay node to easily identify and remove the applied scrambling from the scrambled messages from the client device before they are transmitted to the recipient server.

The information notified to the relay node may comprise the scrambling instruction itself as ordered by the name resolution server to the client device, or only certain elements representative of this scrambling instruction that are sufficient to allow the relay node to be able to remove the scrambling introduced by the client device. For example, in the case of a message padding instruction, the information in question, when it is notified to the relay node by the client device, may be an indicator delimiting or identifying the padding pattern contained in a message (for example, such an indicator may comprise a bit or symbol offset).

The scrambling actions ordered by the name resolution server are advantageously taken into account by the relay node when it receives scrambled messages from the client device containing data destined for the recipient server, in order to identify and then remove the scrambling introduced by the client device before relaying the messages to the recipient server.

The relay node may also, upon receipt of at least one message from the recipient server and containing data destined for the client device, apply scrambling to said at least one message before transferring it to the client device, in a manner transparent to the recipient server.

The scrambling introduced by the relay node may be equivalent to that applied by the client device (in other words of the same kind, for example based on the same padding patterns). This mode is called “symmetric scrambling mode”.

As a variant, the scrambling introduced by the relay node may be different from that applied by the client device; for example, message padding may be applied only in one direction, or different padding patterns may be applied in both directions, or else fake connections may be emulated in one direction (for example from the client device to the relay node) while message padding is applied in the other direction (for example from the relay node to the client device), etc. This mode is called “asymmetric scrambling mode”. This difference in applied scrambling actions makes it possible to take account of the asymmetric character of the volume of the traffic according to its direction. Indeed, a larger amount of payload data is generally transmitted in the relay node to client device direction. These data may, for a given application, have profiles that are constant over time and thus be used for user profiling (and therefore traceability/tracking) purposes. Therefore, applying appropriate scrambling in each of the two directions of communication allows more effective protection of sensitive information relating to the client device or its user.

Furthermore, it should be noted that it is not always possible to apply the same scrambling in the client device to relay node direction and in the relay node to client device direction (for example, it may be the case that messages sent in the client device to relay node direction do not contain as much data as in the opposite direction).

By virtue of the scrambling introduced by the client device, and possibly by the relay node, it is difficult, or even impossible, for a malicious third-party entity to deduce/extract/extrapolate information about traffic from and/or to the client device. Combined with the intervention of the relay node acting as an intermediary between the client device and the recipient server, it is possible to eliminate the implementation of statistical analyses by malicious third-party entities present in the networks involved in routing DNS traffic, or at the very least reduce the scope of such statistical analyses and limit the relevance of the information obtained from such statistical analyses.

The invention therefore makes it possible to guarantee that the confidentiality of communications established by client devices is respected, and contributes to better preserving the privacy of users of these client devices and to limiting risks of user profiling. Network operators may incidentally, through the invention, offer value-added name resolution services (for example DNS services), and thus benefit from the trust of their users. It should be noted that the users in question are not necessarily those to whom the operators provide network connectivity.

As mentioned above, introducing a relay node between the client device and the recipient server aims to mask the actual recipient of the messages sent by the client device, as well as the actual source of these messages (when the messages are inspected unduly beyond the relay node), making it difficult to implement statistical analysis of traffic from the client device. This difficulty may be increased via a judicious choice of the one or more relay nodes to be used by a client device. For example, at least one said relay node may be selected by the name resolution server such that the relay node satisfies at least one of the following conditions:
preventing a correlation between this relay node and the recipient server (for example, one and the same relay node may be used for multiple distinct recipient servers, or different relay nodes may be selected for one and the same client device and one and the same recipient server but for different communications between the client device and the recipient server); and/or
maximizing the number of client devices using said relay node.

These criteria make it possible to limit the risk of a malicious entity tracing communications aimed at name resolution (for example DNS communications).

Other conditions to be satisfied may be taken into account when selecting a relay node for a client device and a recipient server, such as optimizing the client devices using the selected relay node on the basis of at least one given criterion, such as load considerations or geographical considerations (which may relate in particular to the know-how of the operator and/or the engineering/configuration of the relay nodes). According to yet another example, a relay node may be selected because it satisfies a condition of (already) having a route to the recipient server.

It should be noted that the criteria mentioned above are not exclusive; in other words, the name resolution server may take multiple criteria into account simultaneously to select a relay node for the client device and the recipient server.

In one particular embodiment, the plurality of elements transmitted by the resolution server to the client device (and incidentally received by the client device from the resolution server) furthermore comprises a first indication that at least one said relay node may be used by the client device to send at least one second name resolution request correlated with the first request.

In other words, not only is the relay node in question used by the client device to transmit messages to the recipient server, but it is also responsible for resolving all or some of the future client device name resolution queries correlated with the first request, for example relating to a name of a subdomain of a domain name to which the first request related. This makes it possible to introduce an additional degree of scrambling, making it difficult for a malicious entity to establish a link between a particular name resolution server and a client device. Furthermore, each name resolution server involved in the communication of the client device with the recipient server has only partial knowledge of the queries sent by the client device.

It is possible to envisage introducing a degree of granularity in name resolution queries oriented to a relay node. Thus, in one particular embodiment, the plurality of elements transmitted by the resolution server to the client device (and incidentally received by the client device from the resolution server) may furthermore comprise a second indication identifying the name resolution queries that the first indication concerns.

In one particular embodiment, the plurality of elements transmitted by the resolution server to the client device (and incidentally received by the client device from the resolution server) furthermore comprises at least one identifier of said at least one relay node selected by the name resolution server.

This embodiment has multiple advantages.

First of all, it makes it possible to manage situations in which multiple relay nodes may be reachable using one and the same IP address. The identifier transmitted in the plurality of elements allows the client device to distinguish a particular relay node from the plurality of relay nodes sharing the same IP address.

Furthermore, the transmission of the identifier of the relay node selected by the name resolution server makes it possible to dispense with having to keep, on the name resolution server, states associating one or more relay nodes with each client device that contacts it (in this case, reference is made to a stateless name resolution server).

In one particular embodiment, the first request comprises at least one identifier of at least one relay node previously selected for the client device and to which the client device sends all or some of its messages containing data destined for the recipient server.

It should be noted that the relay node in question may have been selected for the client device and for the same recipient server (typically for one and the same communication with this recipient server), by the name resolution server to which the client device addresses the first request or by another name resolution server. The insertion of the identifier of the relay node currently being used by the client device allows the name resolution server to which the first request is addressed, depending on the strategy adopted, either to reselect the same relay node (that is to say at least one said relay node selected by the name resolution server coincides with a relay node identified in the first request), for example to exploit an existing connection, or, on the contrary, to knowingly select a different relay node, so as to make it even more difficult to trace the communications of the client device. Indeed, it is more difficult in the latter case to correlate the recipient server with the identity of the relay contained in the first request.

Moreover, this embodiment makes it possible to limit the information stored by the name resolution server (no need to hold states, as explained above), thereby reinforcing the security of the mechanism implemented by the invention and limiting risks of the client device being traced on the basis of its DNS communications.

In one particular embodiment, the plurality of elements is sent to the client device or received by the client device in a response to the first resolution request.

This embodiment makes it possible to apply the invention without delay from the first resolution request. Furthermore, it advantageously makes it possible to limit the signaling required between the name resolution server and the client device to implement the invention.

It should be noted that the use of the adjectives “first” and “second” is intended solely to distinguish between two successive name resolution queries that are correlated with one another, for example a request relating to a domain name and a subsequent request relating to a subdomain of this domain name. This use does not presuppose the absence of DNS exchanges or more generally previous name resolution between the client device and the name resolution server, for example the client device sending and the name resolution server resolving a request relating to another domain name.

In one embodiment, the sending of said plurality of elements by the name resolution server to the client device is conditional upon the name resolution server detecting a determined option in the first request.

This embodiment offers the possibility for the user of the client device to choose whether or not they wish to benefit from the protection mechanism proposed by the invention. For example, if the network used by the user's client device to access the service provided by the recipient server is a trusted network, the user may decide to deactivate the implementation of the invention. Conversely, if the network is not a trusted network, the user may decide to use the invention. It should be noted that this deactivation may also be carried out by the client device itself automatically, that is to say without the intervention of the user, in a manner transparent to them.

In one particular embodiment, the method for processing a (first) request and messages and/or the communication method are implemented by a computer.

The invention also targets a computer program on a recording medium, this program being capable of being implemented in a computer or more generally in a name resolution server in accordance with the invention and comprising instructions designed to implement a method for processing a first name resolution request as described above.

The invention also targets a computer program on a recording medium, this program being capable of being implemented in a computer or more generally in a client device in accordance with the invention and comprising instructions designed to implement a communication method as described above.

The invention also targets a computer program on a recording medium, this program being capable of being implemented in a computer or more generally in a relay node in accordance with the invention and comprising instructions designed to implement a method for processing messages as described above.

Each of these programs may use any programming language, and be in the form of source code, object code, or of intermediate code between source code and object code, such as in a partially compiled form, or in any other desirable form.

The invention also targets a computer-readable information medium or recording medium comprising instructions of a computer program as mentioned above.

The information medium or recording medium may be any entity or device capable of storing the programs. For example, the medium may include a storage means, such as a ROM, for example a CD-ROM or a microelectronic circuit ROM, or else a magnetic recording means, for example a hard disk, or a flash memory.

Moreover, the information medium or recording medium may be a transmissible medium such as an electrical or optical signal, which may be routed via an electrical or optical cable, by radio link, by wireless optical link or by other means.

The program according to the invention may in particular be downloaded over the Internet.

As an alternative, the information medium or recording medium may be an integrated circuit in which a program is incorporated, the circuit being designed to execute or to be used in the execution of the processing and communication methods according to the invention.

According to another aspect, the invention also relates to a system in a communications network, comprising:
a client device according to the invention;
a name resolution server according to the invention; and
at least one relay node according to the invention selected by the name resolution server for said client device.

The system according to the invention benefits from the same abovementioned advantages as the client device, the name resolution server and the relay node according to the invention.

It is also possible to envisage, in other embodiments, the processing and communication methods, the name resolution server, the client device, the relay node and the system according to the invention having all or some of the abovementioned features in combination.

### BRIEF DESCRIPTION OF THE DRAWINGS

Other features and advantages of the present invention will emerge from the description given below, with reference to the appended drawings, which illustrate one exemplary embodiment thereof that is in no way limiting. In the figures:

FIG. 1 shows, in its environment, a system in a network in accordance with the invention, in one particular embodiment;

FIG. 2 schematically shows the hardware architecture of a computer capable of hosting any one of the entities according to the invention belonging to the system of FIG. 1;

FIG. 3 shows the functional modules of a name resolution server of the system of FIG. 1, in accordance with the invention;

FIG. 4 shows the functional modules of a client device of the system of FIG. 1, in accordance with the invention;

FIG. 5 shows the functional modules of a relay node of the system of FIG. 1, in accordance with the invention;

FIG. 6 shows, in the form of a flowchart, the main steps of a method for processing a name resolution request as they are implemented by the name resolution server of FIG. 3;

FIG. 7 shows, in the form of a flowchart, the main steps of a communication method as they are implemented by the client device of FIG. 4;

FIG. 8 shows, in the form of a flowchart, the main steps of a method for processing messages as they are implemented by the relay node of FIG. 5;

FIGS. 9A and 9B respectively show an option called EAO (for EDNS (Extension Mechanisms for DNS) ASTRA (A DNS-driven Guard Against STatistical Traffic Analysis) Option) able to be used in a name resolution request and in the response to this request to implement the invention, in one particular embodiment;

FIG. 10 partially and schematically illustrates a scrambled message addressed to the relay node of FIG. 5 and containing data destined for the recipient server of FIG. 1;

FIG. 11 schematically illustrates the changes of port numbers and source and destination addresses made by the relay node of FIG. 5, in one particular variant embodiment; and

FIGS. 12A and 12B show the exchanges between the entities of the system 1 of the figure depending on whether or not the client device of the system supports the “partial-offload” function.

### DESCRIPTION OF THE INVENTION

FIG. 1 shows a system 1 in a communications network NW, in accordance with the invention, in one particular embodiment. There is no limitation imposed with regard to the nature of the communications network NW, which may comprise one or more subnetworks, such as for example one or more access (sub)networks (for example a public or private WLAN network, a mobile network, etc.), the Internet, etc.

According to the invention, the system 1 comprises:
a client device 2, in accordance with the invention. In the example of FIG. 1, the client device 2 is a terminal of a user U, such as a mobile telephone (for example a smartphone), connected to a public WLAN network AN1 and to a mobile access network AN2 via both of which it is able to access the Internet. The invention is of course applicable to other fixed or mobile client devices (for example to a decoder such as an STB, a CPE, etc.), and also to other networks (wired, wireless, etc.), the client device 2 being able to be connected simultaneously to one or more access networks, directly or via an intermediate equipment such as a CPE;
at least one trusted name resolution server for the client device 2 (typically considered to be such by the user U of the client device 2), in accordance with the invention, and referenced generally by 3. In the example of FIG. 1, two trusted servers 3 in accordance with the invention are considered by way of illustration. These servers 3-1 and 3-2 are, by way of illustration, domain name resolution servers as defined by IETF document RFC 1034, November 1987, also commonly referred to as DNS servers. However, the invention may be applied in the context of resolving other IP resources, referred to in this document generally as “names”, such as for example URIs, etc. ; and
at least one relay node 4-1, 4-2, etc. in accordance with the invention, referred to more generally by the reference 4 and interfacing with the name resolution servers 3, for example using the RESTCONF protocol described in IETF document RFC 8040, January 2017. Of course, other protocols may be envisaged as a variant for this interface.

In the embodiment described here, the mechanism proposed by the invention, referred to hereinafter as AD ASTRA (for Advanced DNS-driven protection Against Statistical TRaffic Analysis) procedure or mechanism, is activated when the client device 2 uses, to access the Internet and more particularly any service S (for example voice communication service, web service, etc.) hosted or provided by a remote server 5 associated with (that is to say identified by) a given domain name (for example, by way of illustration “service-s.com”), an access network that is not a trusted network for the client device 2. Such a network, called an untrusted network, is for example a public network such as the public WLAN network AN1, or a “visitor” network such as a hotel network, bar network, city network, etc. Indeed, it presents a risk for the client device 2 whereby its communications, in particular with a local DNS server 6 of the network in question, may be intercepted by a malicious third-party entity and, where applicable, exploited by this entity, for example by carrying out statistical analysis, so as to obtain information liable to compromise the privacy of the user U.

By contrast, the AD ASTRA mechanism is deactivated here (although this is not mandatory) when the access network used by the client device 2 is a trusted network for the client device 2, such as for example the mobile network AN2. Such a trusted network is typically a network that has been configured as such by the user U of the client device 2, or according to a default configuration, or else that has been identified as such, for example by using a network identity verification mechanism, etc. As an alternative, a trusted network may also be determined dynamically by validating the assertions of the network, in a manner known per se. The client device 2 is then configured to use, when it wishes to access the service S via such a trusted network, a local trusted DNS server 7 (local to the trusted network), advertised by the trusted network, for example, by way of an advertisement mechanism as described in the document draft-ietf-add-dnr-13 published by the IETF and entitled “DHCP and Router Advertisement Options for the Discovery of Network-designated Resolvers (DNR)”, August 2022. The DNS server 7 may be either a DNS server in accordance with the invention or a DNS server known from the prior art that does not implement the invention.

The activation/deactivation of the AD ASTRA mechanism based on the level of trust granted to the access network used by the client device 2 may be configured by default on the client device 2 (thereby allowing automatic activation or deactivation of the mechanism depending on the conditions of attachment to the network for the client device 2) or be decided upon dynamically, for example by interrogating the user U of the client device 2, via a user interface provided for this purpose.

The trusted DNS servers 3 belong to a list L-DNS of trusted DNS servers, which is configured for example by default on the client device 2 or defined by the user U of the client device 2 (for example via a user interface provided for this purpose). This configuration may have been carried out in particular by the operator of the network providing IP connectivity to the client device 2 (for example its Internet access provider) or by the user U of the client device 2. For simplification, it will be assumed that the list L-DNS contains only trusted DNS servers that support the AD ASTRA mechanism. However, as a variant, the list L-DNS may also contain trusted DNS servers that do not support this mechanism.

In the example of FIG. 1, the DNS servers 3 contained in the list L-DNS are on the Internet; although there is no limitation attached to their actual location, the DNS servers 3 are preferably not located in or advertised by an untrusted network (that is to say by a network that is not a trusted network for the client device 2).

It should be noted that there is no limitation with regard to the number of trusted DNS (or more generally name resolution) servers as specified in the list L-DNS, which may be greater than or equal to 1. In the embodiment described here, it will be assumed that the client device 2 embeds a DNS client referenced CL (for example in an application such as its operating system or OS, the DNS client CL possibly being shared by multiple applications), which chooses, according to a predefined local strategy (for example via a default configuration), the one or more trusted DNS servers to call upon from the list L-DNS for each domain name resolution required when invoking a service, such as for example the service S provided by the remote server 5. This local strategy may in particular specify:
a persistent choice mode, whereby one and the same DNS server is chosen according to a local preference or on the basis of information characteristic of the capacities of the DNS servers in the list L-DNS, and called upon for determined duration;
a sequential choice mode, whereby the DNS client CL establishes a list of candidate servers L-CAND from the list L-DNS, which it orders according to one or more criteria. For example, the list L-CAND is established and ordered on the basis of an encryption scheme supported, where applicable, by each DNS server; such an encryption scheme is for example a DoT, DoD, DoH, DoQ or else DoC encryption scheme as cited above. By way of illustration, the list L-CAND may thus contain all DNS servers in the list L-DNS supporting the DoH encryption scheme, followed by all DNS servers in the list L-DNS supporting the DoT encryption scheme. The DNS servers are then called upon by the DNS client CL in the order of the list L-CAND thus established. Of course, criteria other than encryption schemes may be envisaged as a variant, such as for example the location of the DNS servers, their processing capacity or capacities, etc.;
a random choice mode: a DNS server is chosen randomly by the DNS client CL for any new DNS resolution request. This random choice mode may also result in a random choice of the encryption scheme that is implemented;
etc.

These examples of strategies adopted by the DNS client CL of the client device 2 are given only by way of illustration, and other strategies may be envisaged as a variant. Furthermore, the client device 2 may embed one or more DNS clients CL capable of implementing such a strategy when they are activated.

In the embodiment described here, the communications between the client device 2 (and more specifically its DNS client CL) and a trusted DNS server 3 selected by the DNS client CL of the client device 2 are encrypted. For example, they are in accordance with any one of the DoT, DoD, DoH, DoQ or DoC protocols. Using encrypted DNS transportation to transmit messages between the client device 2 and a DNS server 3 guarantees the authenticity and integrity of these messages.

It will also be assumed, for simplification, that the client device 2 carries out exchanges directly with the trusted DNS server 3, selected by the DNS client CL, without the involvement of a DNS relay (or forwarder). However, the invention is also applicable in the presence of a DNS forwarder located between the client device 2 and the trusted DNS server 3, selected by the DNS client CL. More specifically, if the DNS forwarder is trusted, the client device 2 addresses its DNS queries thereto; in this case, the DNS forwarder is configured to relay DNS queries from the client device 2 to the DNS server 3 selected by the DNS client CL. If the DNS forwarder is not trusted, the client device 2 is configured to address its DNS queries directly to the DNS server 3 selected by the DNS client CL (and thus bypass the DNS forwarder). Thus, for simplification hereinafter, the terminology “DNS request addressed by a client device” designates either a DNS request directly from the client device or via a DNS forwarder, as has just been mentioned.

According to the invention, when the AD ASTRA mechanism is activated and a trusted DNS server 3 is called upon by the client device 2 to resolve a domain name associated with the service S hosted by the remote server 5, the DNS server 3 in question is configured, in addition to resolving the domain name in question (directly or indirectly by calling upon another DNS server), to select one or more relay nodes from the relay nodes 4 of the system 1 to which the client device 2 should be directed to send its messages containing data destined for the remote server 5 (recipient server within the meaning of the invention), sent in the context of the service S. The communications between the client device 2 and the selected one or more relay nodes 4 of the system 1, and also between these relay nodes 4 and the DNS servers 3 that selected them, are encrypted in the embodiment described here, for example by way of the TLS (Transport Layer Security) protocol, version 1.3, possibly combined with the use of an ECH (Encrypted Client Hello) function. Of course, this hypothesis is not limiting per se, and other encryption protocols and extensions may be envisaged as a variant in the context of the invention.

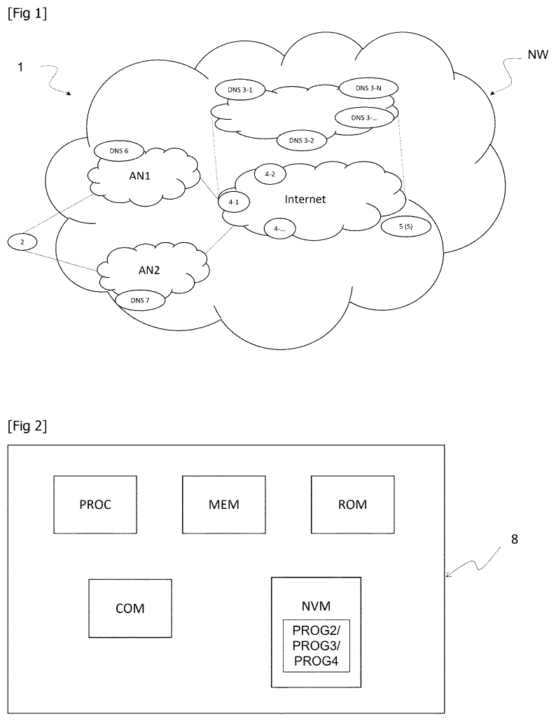

In the embodiment described here, the client device 2, the DNS servers 3 and the relay nodes 4 have the hardware architecture of a computer 8, as shown schematically in FIG. 2. This hardware architecture is based on a processor PROC, a random access memory MEM, a read-only memory ROM, a non-volatile memory NVM, and communication means COM enabling each of the abovementioned devices to communicate in particular with the other devices of the system 1. These communication means COM may in particular rely on a wired or wireless communication interface, which is known per se and not described in detail here, and/or on one or more software interfaces such as an application programming interface (API) or a point-to-point communication interface, etc., and implement one or more encryption schemes as mentioned above.

The non-volatile memory NVM (or, as a variant, the read-only memory ROM) of the computer 8 constitutes a recording medium in accordance with the invention, able to be read by the processor PROC and on which there is recorded a computer program in accordance with the invention.

In the case of a DNS server 3 in accordance with the invention, this computer program is referenced PROG3 and comprises instructions defining the main steps of a method for processing a (first) name resolution request according to the invention. In the case of the client device 2 in accordance with the invention, this computer program is referenced PROG2 and comprises instructions defining the main steps of a communication method according to the invention. Lastly, in the case of a relay node 4 in accordance with the invention, this computer program is referenced PROG4 and comprises instructions defining the main steps of a method for processing messages according to the invention.

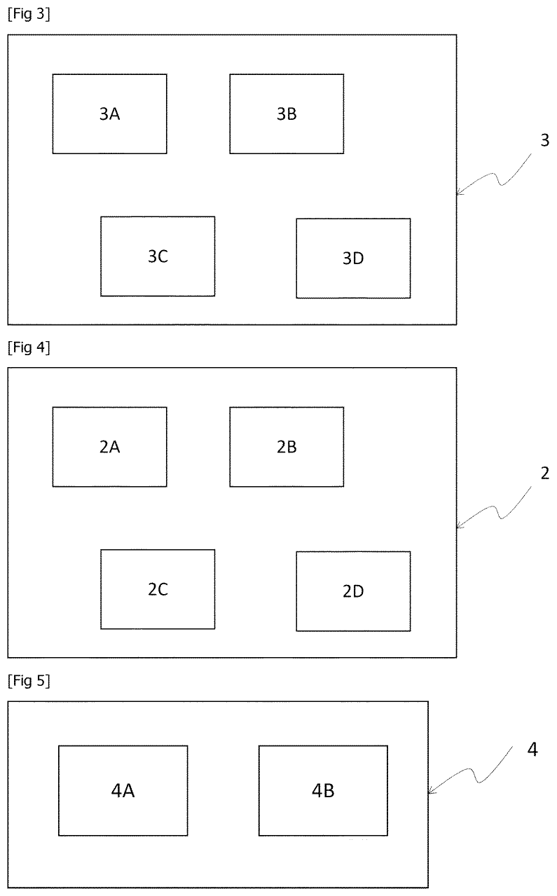

The computer program PROG3 defines the functional modules of a DNS server 3 in accordance with the invention, which rely on or control the elements PROC, MEM, ROM, NVM and COM of the computer 8. In the embodiment described here, these functional modules comprise in particular, as illustrated in FIG. 3:
a reception module 3A, configured to receive name resolution queries REQ-DNS (DNS queries in the example envisaged here) sent by client devices, and in particular by the client device 2;
a processing module 3B, configured to process (in other words resolve) the queries REQ-DNS received by the reception module 3A and prepare responses REP-DNS to these queries;
a provision module 3C, configured to provide to each client device that has called upon the DNS server 3, supporting (and incidentally calling upon) the implementation of the AD ASTRA mechanism, a plurality of elements AD ASTRA-ELTS in addition to the information conventionally provided in response to a request REQ-DNS, as described in more detail later. In the embodiment described here, the plurality of elements AD ASTRA-ELTS is provided to a client device that has addressed a request REQ-DNS to the DNS server 3 in the response REP-DNS to this request, for example in an EDNS (Extension Mechanisms for DNS) option, as explained in more detail later. These hypotheses are however not limiting, and it may be envisaged for the plurality of elements AD ASTRA-ELTS to be provided to the client device using one or more messages distinct from the response REP-DNS; and

a sending module 3D, configured to send, to the client devices that have called upon the DNS server 3, the responses REP-DNS prepared by the processing module 3B and also the plurality of elements AD ASTRA-ELTS provided by the provision module 3C.

In order to resolve a request REQ-DNS received from a client device, the processing module 3B, as is conventional, based on records RR that the DNS server 3 possess or that it is able to access (via one or more other DNS servers that are organized hierarchically), establishes a match between the name to which the request REQ-DNS relates (for example, the domain name “service-s.com” for accessing the service S) and an IP resource (for example an IP address) of a server associated with this name (the server 5 in the example of the domain name “service-s.com”).

In the example envisaged here, for simplification, a limit is drawn at A records RR (establishing a match between a name and an IPv4 address of a server associated with this name) and AAAA records RR (establishing a match between a name and an IPv6 address of a server associated with this name), a server associated with a name being able to be identified by an IPv4 address and/or an IPv6 address (and thus correspond to an A record and/or an AAAA record). It should be noted that the invention is however not limited to these two types of records, and is also applicable to other types of records RR, such as SVCB (service binding), SRV (service resource record), CNAME, etc. records RR, which may associate, with names, resources other than an IP address, such as for example an alias, another name, a URI, etc.

The response REP-DNS to the request REQ-DNS prepared by the processing module 3B thus comprises at least one item of information contained in a record RR relating to a server (referred to here as “recipient server”) associated with the name to which the request REQ-DNS relates, and resulting from the resolution of the request REQ-DNS by the processing module 3B. In the example envisaged here of A and AAAA records RR, this information comprises at least one IP (IPv4 and/or IPv6) address of the recipient server.

As mentioned above, this response REP-DNS furthermore comprises, in the embodiment described here, the plurality of elements AD ASTRA-ELTS provided by the provision module 3C of the DNS server 3. This plurality of elements AD ASTRA-ELTS comprises, according to the invention, at least the following elements:
at least one IP address of at least one relay node 4 selected by the DNS server 3 (for example by its provision module 3C) for the client device 2 and for the recipient server associated with the name to which the request REQ-DNS relates (remote server 5 in the example envisaged), to which the client device has to send all or some of its messages containing data destined for the recipient server. This IP address may possibly be supplemented by a port number to be used by the client device to address its messages to the relay node 4, if a default port number is not defined. In other words, instead of addressing the messages relating to the service it wishes to access to the recipient server identified in the response REP-DNS, the client device has to address these messages to the relay node 4 (that is to say indicate the address of the relay node 4 as the destination address for these messages instead of the address of the recipient server). The recipient server for which the payload data contained in these messages are actually destined remains, however, identified in the content of the messages addressed to the relay node 4-1 so that it is able to relay these payload data to the recipient server. Thus, in the envisaged example of the service S, if the plurality of elements AD ASTRA-ELTS designates the relay node 4-1, this means that the client device 2 has to address the messages containing data destined for the remote server 5 to the relay node 4-1. Each message addressed to the relay node 4-1 has, as its destination address, the address of the relay node 4-1 (including its IP address denoted @IP4-1 and a port number P4-1, which may be defined by default or have been provided by the DNS server 3 with the IP address of the relay node 4-1 as mentioned above), and contains a data packet, called an inner data packet, encrypted by way of an encryption scheme (for example TLS, DTLS). The inner data packet contains payload data destined for the remote server 5 and has, as its destination address, the IP address of the remote server 5 and its port number (also more commonly referred to as “transport address”). The address of the remote server 5 is therefore masked by way of encryption in the content of the message addressed to the relay node 4-1; and

at least one scrambling instruction INST, intended to be applied (in other words that is to be applied) by the client device 2 to said messages containing data destined for the recipient server before addressing them to said at least one relay node 4. Such a scrambling instruction may comprise for example a padding instruction to pad all or some of the messages, and/or an instruction to emulate connections between the client device and the relay node or via the relay node to a dedicated server in addition to the connection used to send the messages containing the data destined for the recipient server (in other words, an instruction for the client device to establish “fake” connections), as explained further below.

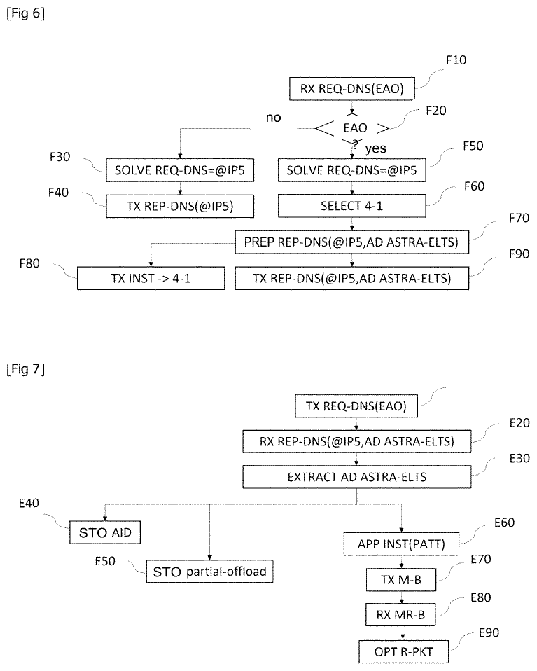

The configuration and operation of the modules 3A to 3D of a DNS server 3 in accordance with the invention are described in more detail with reference to the steps of the method for processing a (first) name resolution request that are illustrated in FIG. 6.

With regard to the client device 2, the program PROG2 stored in the memory NVM (or as a variant ROM) of the computer 8 defines the functional modules of the client device 2, which rely on or control the elements PROC, MEM, ROM, NVM and COM of the computer 8. In the embodiment described here, these functional modules comprise in particular, as illustrated in FIG. 4:

a sending module 2A, embedded in the DNS client CL, and configured to send a name resolution request REQ-DNS to one of the DNS servers 3 in the list L-DNS chosen by the DNS client CL of the client device 2. In the example envisaged here, this request REQ-DNS relates to a domain name and to an A or AAAA record RR attached to this domain name. The sending module 2A is activated by the DNS client CL each time the client device 2 wishes to access a service, for example the service S hosted by the remote server 5 and associated with the domain name “service-s.com”. In the embodiment described here, the request REQ-DNS furthermore comprises an EDNS EAO option, indicating to the DNS server 3 that is called upon that the client device 2 supports (and incidentally calls upon) the AD ASTRA mechanism. As a variant, the fact that the client device 2 supports the AD ASTRA mechanism may be signaled to the DNS server 3 by other means (for example in a message other than in the request REQ-DNS, in another option, etc.);
a reception module 2B, embedded in the DNS client CL and configured to receive, from the DNS server 3 that is called upon, the response REP-DNS to the request REQ-DNS prepared thereby. This response REP-DNS comprises, as indicated above, at least one item of information relating to the record RR requested by the client device 2 from the recipient server associated with the name to which the request REQ-DNS relates, for example an IP address of the recipient server. Furthermore, in the embodiment described here, the response REP-DNS contains the plurality of elements AD ASTRA-ELTS provided by the DNS server 3 in accordance with the AD ASTRA mechanism;
an execution module 2C, configured to apply said at least one scrambling instruction contained in the plurality of elements AD ASTRA-ELTS to messages containing data destined for the recipient server associated with the name to which the request REQ-DNS relates before addressing them to one of the relay nodes 4 identified in the plurality of elements AD ASTRA-ELTS; and
a sending module 2D configured to send, to the relay node 4 in question, the scrambled messages obtained by the execution module 2C.

The configuration and operation of the modules 2A to 2D of the client device 2 according to the invention are described in more detail with reference to the steps of the communication method that are illustrated in FIG. 7.

Similarly, the program PROG4 stored in the memory NVM (or as a variant ROM) of the computer 8 defines the functional modules of a relay node 4 in accordance with the invention, these functional modules relying on or controlling the elements PROC, MEM, ROM, NVM and COM of the computer 8. In the embodiment described here, they comprise in particular, as illustrated in FIG. 5:
an acquisition module 4A, configured to acquire information relating to at least one scrambling instruction INST applied by a client device in accordance with the invention such as the client device 2, for which the relay node 4 has been selected, said scrambling instruction INST being applied to messages containing data destined for a recipient server before the client device addresses them to the relay node 4. The information relating to the scrambling instruction INST may be acquired via the trusted DNS server 3 at the origin of this instruction or by the client device configured to apply it; and
a processing module 4B, configured to:
   upon receipt of such a message, remove the scrambling applied by the client device to the message in accordance with the scrambling instruction INST using the acquired information; and
   transfer the message obtained after removal of the scrambling to the recipient server. It should be noted that the relay node 4 may transfer the obtained message directly to the recipient server or via another relay node, in the case where multiple relay nodes are deployed in cascade. The way in which the processing module 4B works presents no difficulty for those skilled in the art and is not described in more detail here.

In the embodiment described here, the module 4B is furthermore configured, upon receipt of a message from the recipient server and destined for the client device for which it has been selected (for example for the client device 2), to scramble this message and transfer the obtained scrambled message to the client device. It should be noted that the module 4B does not necessarily apply the scrambling that has been applied in the client device to relay node direction in the relay node to client device direction (that is to say the scrambling applied in one direction and in the other is not necessarily the same). The scrambling applied in the relay node to client device direction is chosen for example by the trusted DNS server 3. If it differs from that applied in the client device to relay node direction, the relay node 4 is informed of this for example by the trusted DNS server 3 and receives therefrom, via its acquisition module 4A, a scrambling instruction INST′ describing the scrambling to be applied. As an alternative, the instruction for the identification of the scrambling is encoded explicitly in the encrypted message and therefore communicated by the client device (respectively the relay node).

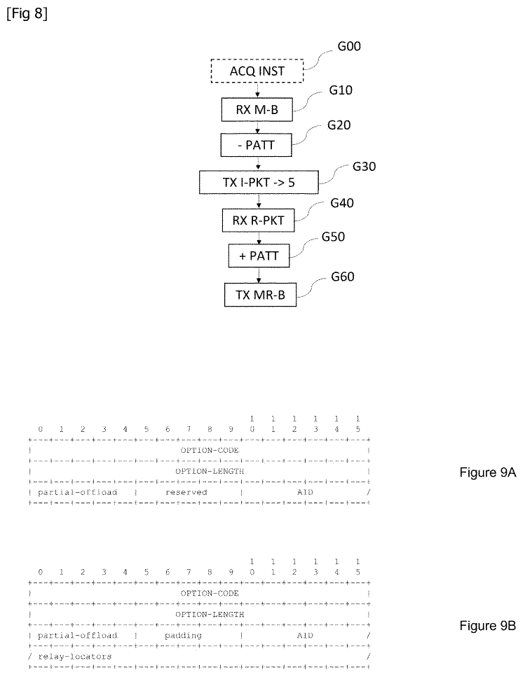

The configuration and operation of the modules 4A and 4B of a relay node 4 according to the invention are described in more detail with reference to the steps of the method for processing messages that are illustrated in FIG. 8.

A description will now be given, with reference to FIGS. 6 to 8, of the main steps of the method for processing a name resolution request (FIG. 6), of the communication method (FIG. 7) and of the method for processing messages (FIG. 8) according to the invention, as are implemented respectively by a DNS server 3 (in the example envisaged below, the DNS server 3-1), the client device 2 and a relay node 4 (in the example envisaged below, the relay node 4-1) in accordance with the invention, in one particular embodiment.

With reference to FIG. 7, as mentioned above, it will be assumed in the embodiment described here that the client device 2 is configured (for example, by its Internet access provider or by its user) with a list L-DNS of trusted DNS servers 3, in accordance with the invention, supporting the AD ASTRA mechanism.

In a manner known per se, when a client device such as the client device 2 wishes to access, via an application installed on the client device for example, a service hosted within a computing environment, the application in question sends, to a DNS server, a DNS request relating to the name (in the DNS sense) of the computing environment in order to obtain the address (for example an IP address) of a server with which to carry out exchanges in order to benefit from the service.

It will be assumed here that the client device 2 wishes to access, via an application APP, the service S associated with the domain name “service-s.com”and hosted by the remote server 5.

The client device 2 then sends, via its sending module 2A, a request REQ-DNS to resolve the domain name “service-s. com” (first request within the meaning of the invention) to one of the trusted DNS servers 3 identified in the list L-DNS, namely here to the DNS server 3-1 (step E10). The choice of the DNS server 3-1 from the list L-DNS results from a local strategy applied by the client device 2 and that has been configured beforehand in the client device 2, as mentioned above. It should also be recalled that the exchanges between the client device 2 and the DNS server 3-1 (DNS queries and responses to the DNS queries in particular) are encrypted, for example using one of the abovementioned DoT, DoD, DoH, DoQ or else DOC encryption schemes.

The request REQ-DNS, in a manner known per se, specifies in particular the domain name “service-s.com” that the client device 2 wishes to access, as well as the type of record RR targeted by the request (for example here an A record RR if the client device 2 supports the IPv4 protocol or an AAAA record RR if the client device 2 supports the IPv6 protocol). In the embodiment described here, the request REQ-DNS furthermore comprises an EDNS option called EAO (newly introduced for the purposes of the invention), indicating to the DNS server 3 that is called upon, that is to say the DNS server 3-1, that the client device 2 supports and is calling upon the implementation of the AD ASTRA mechanism.

FIG. 9A illustrates one exemplary format of the EAO option inserted by the client device 2 in its request REQ-DNS, indicating to the DNS server 3-1 that the client device 2 supports and is calling upon the implementation of the AD ASTRA mechanism. In accordance with document RFC 6891 published by the IETF and entitled “Extension Mechanisms for DNS (EDNS(0))”, April 2013, the EAO option comprises three fields OPTION-CODE, OPTION-LENGTH and OPTION-DATA, the OPTION-LENGTH field indicating the size in bytes of the OPTION-DATA field.

In the example illustrated in FIGS. 9A and 9B, the OPTION-DATA field comprises a “partial-offload” parameter and an “AID” (AD ASTRA relay IDentifier) parameter, and also a reserved location, allowing the client device 2 to communicate capabilities that it possesses in connection with the AD ASTRA mechanism as well as other information that may be useful to the DNS server 3 that is called upon. More particularly:
the “partial-offload” parameter is used by the client device 2 in a request to indicate to the DNS server 3-1 whether it supports (parameter set to 1 for example) or does not support (parameter set to 0 for example) the sending of a first name resolution request to the DNS server 3-1 (request REQ-DNS) and then the sending of subsequent name resolution queries (second queries within the meaning of the invention, denoted REQ′-DNS, REQ″-DNS, etc.), correlated with the first name resolution request REQ-DNS, to a name resolution server other than the DNS server 3-1, whose reachability information (for example its IP address) is communicated thereto by the DNS server 3-1. This other name resolution server may typically be a relay node selected by the DNS server 3-1 in accordance with the invention. The term “correlated queries” is understood here to mean that there is a link between the two questions asked in the two queries, for example the first request relates to the resolution of a “parent” domain name (for example “service-s.com”), whereas the second request relates to the resolution of a name of a subdomain of the parent domain (that is to say “*.service-s.com” in the example envisaged above where * denotes a character string). Another example of correlation is the client device 2 discovering names (or references or else referrals) requiring resolution during the processing of data sent by the recipient server resulting from the resolution of the first request; the one or more second queries sent to resolve these names are correlated, within the meaning of the invention, with the first request. The correlation is established by the client device 2 as soon as it associates the recipient server as the source of the names. The “partial-offload” parameter may be set to 0 by default. In the remainder of the description, if the “partial-offload” parameter is set to 1 by the client device 2, it is said that this supports the “partial-offload” function (function of “offloading” DNS queries to a server other than the DNS server 3-1 responsible for processing the first request REQ-DNS); and
the “AID” parameter is used by the client device 2 to indicate whether it is already using, for active connections, a relay node in accordance with the invention, in the context of implementing the AD ASTRA mechanism for the service S associated with the domain name “service-S.com” hosted by the server 5 (in other words to send messages containing data destined for the server 5) and, where applicable, an identifier of this relay node. There is no limitation imposed with regard to the form of the identifier in question: it may be an alias, a number, a domain name, a hash, etc. The client device 2 may possibly associate this identifier with a preference intended for the DNS server 3-1, for example “match” if it wants the DNS server 3-1 to select the same relay node when it processes the request REQ-DNS, or “not match” to request the use of another relay node. In the embodiment described here, this preference is not necessarily binding for the DNS server 3-1, and might not be taken into account thereby. Of course, this is only an implementation choice and it is possible, as a variant, to envisage this preference of the client device 2 being binding for the DNS server 3-1.

With reference to FIG. 6, upon receipt of the request REQ-DNS by its reception module 3A (step F10), the DNS server 3-1 determines whether the latter contains the EAO option (test step F20).

If the request REQ-DNS does not contain the EAO option (response “no” to test step F20), the DNS server 3-1 processes (that is to say resolves) the request REQ-DNS via its processing module 3B in a manner that is conventional and known to those skilled in the art, based on the records RR that it possesses or by interrogating one or more other DNS servers as mentioned above (step F30), and then sends its response REP-DNS-0 to the client device 2 (step F40). This response REP-DNS-0 here comprises the IP address, denoted @IP5, of the server 5 associated with the domain name “service-s.com”.

If the request REQ-DNS contains the EAO option (response “yes” to test step F20), as is the case in the example envisaged here, the DNS server 3-1 processes (resolves) the request REQ-DNS via its processing module 3B in a manner that is conventional and known to those skilled in the art, based on the records RR that it possesses or by interrogating one or more other DNS servers (step F50). This processing is identical to that carried out in step F30.

The processing module 3B of the DNS server 3-1 obtains, by resolving the request REQ-DNS, the record RR from the server 5 (recipient server within the meaning of the invention) associated with the domain name “service-s.com”, and more particularly its IP address @IP5, which is contained in this record RR (information relating to the recipient server resulting from the resolution of the request REQ-DNS within the meaning of the invention). It includes the address @IP5 in the response REP-DNS to the request REQ-DNS.

Moreover, according to the invention, the DNS server 3-1, supporting the AD ASTRA mechanism, selects, via its provision module 3C, at least one relay node 4 for the recipient server 5 (step F60). In the example envisaged here, it selects the relay node 4-1. The relay node 4-1 that is thus selected is intended to be used by the client device 2 to address thereto the messages that it wishes to send to the recipient server 5, in the context of it accessing the service S (instead of sending them directly to the recipient server 5). The relay node 4-1 is then responsible for relaying these messages to the recipient server 5, directly or via another relay node 4 when relay nodes are deployed in cascade.

It should be noted that, if the request REQ-DNS is addressed by the client device 2 to a trusted DNS server that does not support the AD ASTRA mechanism and in particular the EAO option (for example when the list L-DNS contains both trusted DNS servers that support the AD ASTRA mechanism and trusted DNS servers that do not support it), then said server responds to the client device 2 by sending it an error message. Upon receipt of the error message, the client device 2 may call upon another DNS server, send the request back to the same server but without the EAO option, terminate the communication and generate a local notification (application, user, etc.) indicating failure of the resolution attempt, etc.

To select a relay node 4 for a recipient server 5 and a client device 2, the provision module 3C of the DNS server 3-1 may take into account one or more selection criteria. In particular, the provision module 3C may select a relay node 4 that satisfies one or more conditions among the following conditions:
preventing the establishment of a correlation between the selected relay node 4 and the recipient server. Typically, the provision module 3C has to prevent a relay node 4 from being selected only for a single recipient server, or for separate communications between the client device 2 and the recipient server, it may select different relay nodes 4;
maximizing the number of client devices using a selected relay node 4;
optimizing client devices using a selected relay node 4 on the basis of at least one given criterion, such as for example load considerations, geographical considerations, etc.;
(already) having a route from the selected relay node 4 to the recipient server. This information may be obtained by the provision module 3C by interrogating the relay nodes 4 of the system 1 in order to obtain the routing tables maintained thereby;
etc.

In another embodiment, the provision module 3C of the DNS server 3-1 may randomly select a relay node 4 from a list of relay nodes with which it has been configured beforehand.

Moreover, as mentioned above, the DNS server 3-1 may also select a plurality of relay nodes by applying the criteria mentioned above, each relay node being intended to be used by the client device 2 for a determined duration (for example the duration of a connection).

In addition, if the EAO option of the request REQ-DNS comprises an identifier AID of a relay node previously selected for the client device 2 and the recipient server 5 associated with the service S, the DNS server 3-1 may take this identifier AID into account when selecting the relay node (and, where applicable, the preference associated with this identifier AID indicated by the client device 2). For example, if the client device 2 has inserted an identifier AID of a relay node 4 in the EAO option, the DNS server 3-1 may select a relay node 4 so as to avoid associating one and the same relay node with one and the same recipient server for this client device 2, in order to minimize the risk of DNS communications of the client device 2 being traced by a malicious entity (such an entity would in fact have great difficulty in then establishing a correlation between the recipient server and the identifier of the relay node). As a variant, it may decide to select a relay node matching the one identified in the identifier AID of the request REQ-DNS.

It should however be noted that, depending on its configuration, the DNS server 3-1 may ignore the indications provided by the client device 2 in the “AID”parameter of the EAO option of the request REQ-DNS.

Following the selection of at least one relay node 4 (the relay node 4-1 in the illustrative example envisaged), the provision module 3C inserts, in an EDNS EAO option of the response REP-DNS to the request REQ-DNS, an address of the selected one (or more) relay nodes (step F70). In the embodiment described here, this address is an IP address (IPv4 address or IPv6 address). It forms part of the plurality of elements AD ASTRA-ELTS provided by the provision module 3C to the client device 2.

As a variant, it is possible to envisage providing a domain name associated with each selected relay node as a reachability address, instead of an IP address. Using an IP address has the advantage of not requiring additional name resolution (thereby allowing the client device 2 to access the service S more quickly).

In yet another variant, the address inserted by the provision module 3C is a transport address of the relay node 4 and comprises an IP address of the relay node 4 and also a port number to be used.

FIG. 9B illustrates one exemplary format of the EAO option inserted by the DNS server 3-1 in its response REP-DNS (which echoes the EAO option inserted by the client device 2 in its request REQ-DNS). As shown in this figure, the OPTION-DATA field of the EAO option comprises multiple parameters, including in particular a “relay-locators” parameter, in which the IP address of the selected relay node 4-1 (or the IP addresses of the selected relay nodes) is (are) inserted.

Moreover, in accordance with the invention, the provision module 3C also inserts into the EAO option of the response REP-DNS, in the plurality of elements AD ASTRA-ELTS that it provides to the client device 2, at least one scrambling instruction INST to be applied thereby to the messages that it will address to the relay node 4-1 and that are destined for the recipient server.

In the embodiment described here, the scrambling instruction INST consists of a padding instruction to pad (or else fill) the messages sent by the client device 2 before they are sent to the relay node 4-1. This is inserted into a “padding” parameter in the OPTION-DATA field of the EAO option, as illustrated in FIGS. 9A and 9B. This padding instruction is an instruction to supplement the messages destined for the recipient server that the client device 2 sends to the relay node 4-1 so as to homogenize their sizes. The one or more padding patterns applied by the client device 2, denoted PATT, are chosen for example so as to make the template of the messages sent by multiple client devices uniform. This advantageously makes it possible to further reinforce the anonymity of the communications of the client devices in question.

The padding instruction inserted in the “padding” parameter by the provision module 3C may take numerous forms. It may comprise a generation technique to be used by the client device 2 to generate one or more padding patterns PATT. Such a technique may be based for example on a reinforcement learning technique enabling the client device 2 to determine the padding patterns to be applied and to adjust them over time if necessary.

As a variant, such a generation technique may be applied directly by the provision module 3C of the DNS server 3-1, and the padding instruction inserted in the “padding” parameter may record the one or more padding patterns PATT generated by the provision module 3C by way of this generation technique.

In the embodiment described here, the provision module 3C also notifies the relay node 4-1 selected for the client device 2 and the recipient server 5 of the content of the padding instruction (and more particularly of the one or more padding patterns PATT or of the technique for generating such patterns) that it asks the client device 2 to apply to the messages destined for the recipient server 5 that it will send to the relay node 4-1 (step F80).

This notifying of the relay node 4-1 by the DNS server 3-1 allows it to acquire information relating to the one or more scrambling instructions ordered by the DNS server 3-1 to the client device 2 and thus to be able to process messages from the client device 2 containing data destined for the recipient server 5 before relaying them to the recipient server 5.

As a variant, the relay node 4-1 may acquire such information from the client device 2 itself. For example, in the case of a padding instruction, the client device 2 may notify the relay node 4-1 by inserting, in its messages containing data destined for the recipient server 5 and addressed to the relay node 4-1, indicators delimiting or identifying the padding patterns applied.

In another embodiment, the scrambling instruction INST may comprise an instruction for the client device 2 to establish one or more fake connections to the relay node 4-1 and/or via the relay node 4-1 (to one or more dedicated servers), in addition to its “main” connection established with the relay node 4-1 to transmit data to the recipient server 5 in the context of the client device 2 accessing the service S. The client device 2 then uses these fake connections to transmit “fake” data to the relay node 4-1 and/or to the one or more dedicated servers, in other words data that are not strictly speaking intended to be exploited (“consumed”) by the relay node 4-1 and/or by the one or more dedicated servers, but that are intended solely to scramble the data destined for the recipient server 5. This instruction to establish fake connections may be inserted in an appropriate parameter of the OPTION-DATA field of the EAO option, and be notified to the relay node 4-1 as described above for the padding instruction.

Of course, other scrambling instructions may be transmitted by the DNS server 3-1 to the client device 2 for the purpose of introducing noise around the connection of the client device 2 to the recipient server (remote server 5 in the example envisaged here) and making it difficult to exploit information intercepted by a malicious entity placed on the path of this connection. They are also notified to the relay node 4-1 so that it is able to take them into account when receiving scrambled messages from the client device 2.

In the embodiment described here, the provision module 3C of the DNS server 3-1 provides two other elements in the plurality of elements AD ASTRA-ELTS inserted in the EAO option of the response REP-DNS, namely:
an “AID” parameter, in which the provision module 3C of the DNS server 3-1 supplies an identifier of the relay node 4-1 whose address appears in the “relay-locators” parameter, and which it has selected for the domain name “service-s.com” and the recipient server 5. If multiple relay nodes are selected, the “AID” parameter comprises the identifiers of each of the selected relay nodes. As indicated above, there is no limitation attached to the form of the identifier in question: it may be an alias, a number, a domain name, a hash, etc. ;
a “partial-offload” parameter: if the client device 2 has indicated, in the “partial-offload” parameter of the EAO option of the request REQ-DNS, that it supports the partial-offload function, the DNS server 3-1 indicates, in the “partial-offload” parameter of the EAO option of its response REQ-DNS, whether the relay node it has selected (relay node 4-1) is able to take over subsequent DNS exchanges of the client device 2 that are correlated with the request REQ-DNS (that is to say the “second” queries within the meaning of the invention), in other words whether it supports the partial-offload function. The provision module 3C may optionally add, to the “partial-offload” parameter, an additional indication identifying the DNS queries concerned by the partial-offload function (for example queries relating to a particular subdomain or any other filter such as the origin of DNS resources (domain names (for example “service. example. com”), service (SRV, for example “service._tcp.example.com”), etc.) to be submitted to the DNS system). By way of illustration, in the example envisaged here of a request REQ-DNS relating to the domain name “service-s.com”, the fact that the relay node 4-1 supports the “partial-offload” function indicates to the client device 2 that it is able to send all of its subsequent queries relating to a subdomain “*.service-s.com” to the relay node 4-1. It should be noted that the fact that the relay node 4-1 supports the partial-offload function does not necessarily imply that subsequent DNS queries sent by the client device 2 are processed (that is to say resolved) directly by the relay node 4-1. Indeed, said relay node may be configured to address these queries to another trusted DNS server capable of resolving them.

The various elements indicated by the DNS server 3-1 in the “relay-locators”, “AID” and “partial-offload” parameters constitute, as mentioned above, a plurality of elements AD ASTRA-ELTS provided by the provision module 3C of the DNS server 3-1 to the client device 2. In the embodiment described here, this plurality of elements is provided in the response REP-DNS to the request REQ-DNS, in an EAO option. As a variant, all or some of this plurality of elements may be provided in one or more options or messages distinct from the response REP-DNS.

The response REP-DNS including the EAO option is then sent by the sending module 3D of the DNS server 3-1 to the client device 2 (step F90).

With reference to FIG. 7 again, the client device 2, and more particularly its reception module 2B, receives the response REP-DNS prepared by the DNS server 3-1 to its request REQ-DNS (step E20).

The client device 2 extracts, from the EAO option, the plurality of elements AD ASTRA-ELTS present in the response REP-DNS, and more particularly the elements contained in the “relay-locators”, “padding”, “AID” and “partial-offload” parameters of the option (step E30). It will be recalled that the use of encrypted DNS transport to transmit these parameters advantageously guarantees the authenticity and integrity of the messages carrying these parameters, and therefore incidentally of the parameters received by the client device 2.

The identifier AID is recorded by the reception module 2B in a local cache of the DNS client CL of the client device 2, in association with the corresponding IP resource, namely here the domain name “service-s.com”. If an entry is already present in the cache for this same resource, the DNS client CL replaces its content with the new AID supplied in the response REP-DNS. When sending subsequent DNS queries correlated with the request REQ-DNS, the DNS client CL supplies the “AID” parameter of the EAO option of these subsequent DNS queries with the current content of the local cache.

If the client device 2 supports the partial-offload function (as is the case in the example envisaged here), the reception module 2B also records, in the local cache of the DNS client CL, the information transmitted in the “partial-offload” parameter, namely that all or some of the relay nodes indicated in the “relay-locators” parameter may be used for subsequent DNS queries correlated with the first request REQ-DNS and, where applicable, the additional indications provided by the DNS server 3-1 and identifying the subsequent DNS queries concerned (step E50). It should be noted that, in the embodiment described here, the “partial-offload” parameter is supplied by the DNS server 3-1 in the EAO option of the response REQ-DNS only if the client device 2 supports the partial-offload function and has notified this to the DNS server 3-1 by setting the “partial-offload”parameter of the request REQ-DNS to 1.

The scrambling instruction INST contained in the “padding” parameter (message padding instruction here) is transmitted by the reception module 2B to the application APP of the client device 2 at the origin of the request REQ-DNS to resolve the domain name “service-s.com”, so that it is able to execute (that is to say apply) this instruction before sending messages destined for the recipient server 5 to the relay node 4-1 indicated in the “relay-locators” parameter (step E60). To this end, the application APP comprises an execution module 2C according to the invention. It should be noted that all of the modules 2A to 2D of the client device 2 may be hosted in the application APP.

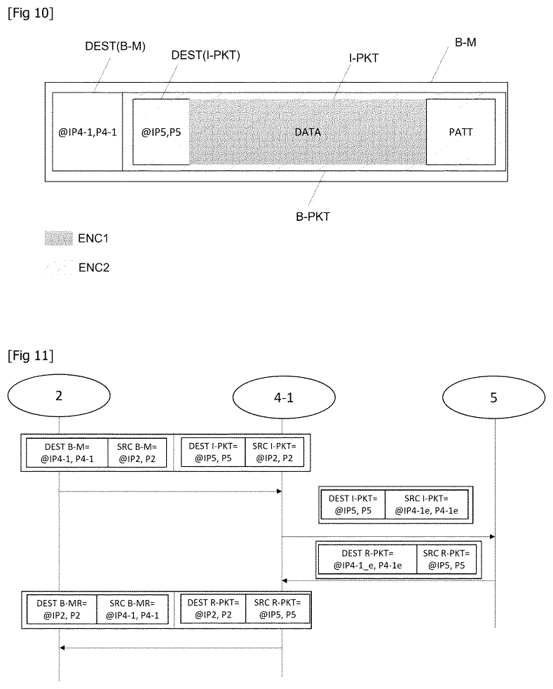

As illustrated schematically in FIG. 10, the messages destined for the recipient server 5 contain payload data DATA exchanged by the application APP with the recipient server 5 when accessing the service S. As mentioned briefly above, these data are encrypted by way of a first encryption mechanism ENC1 according to the needs of the service S offered by the recipient server 5, and recorded in inner data packets denoted I-PKT (inner packets). Each inner data packet I-PKT is destined for the recipient server 5, that is to say its destination address (contained in a header of the IP packet I-PKT referenced DEST in FIG. 10) is the IP address @IP5 of the recipient server 5 and the port number P5 of the recipient server 5. This port number is for example here a port number that is defined by default (as a variant, it may have been obtained during the resolution of the domain name associated with the recipient server 5, in a manner known per se). The inner data packet I-PKT constitutes a data packet destined for the recipient server within the meaning of the invention. The application APP then applies, by way of its execution module 2C, the scrambling instruction INST recorded in the elements AD ASTRA-ELTS to each inner data packet I-PKT containing data destined for the recipient server 5 (step E60). As mentioned above and illustrated in FIG. 10, in the embodiment described here, the scrambling instruction INST is a padding instruction comprising at least one padding pattern PATT or a technique for generating such a pattern PATT. As a result, the application APP adds padding bits or symbols in accordance with the one or more padding patterns PATT indicated in the padding instruction INST or generated by the execution module 2C by applying the generation technique indicated in the padding instruction INST. The application APP thus obtains what is referred to as a scrambled data packet B-PKT, consisting of the inner data packet I-PKT supplemented by the padding bits or symbols of the applied one or more padding patterns PATT.

It should be noted that, in the example illustrated in FIG. 10, the padding pattern PATT is inserted after the data DATA. However, this hypothesis is not limiting per se; the padding pattern PATT may be inserted at other locations, or be fragmented and interleaved in the middle of the data DATA.

In the embodiment described here, the scrambled data packet B-PKT is then encrypted (in accordance with the encryption scheme applied, where applicable, between the client device 2 and the relay node 4-1, referenced ENC2 in FIG. 10), and then inserted by the execution module 2C into a message B-M whose destination address comprises the IP address of the relay node 4-1 denoted @IP4-1 (or of one of the relay nodes 4 supplied in the “relay-locators” parameter) provided by the plurality of elements AD ASTRA-ELTS, and its port number P4-1. This port number may be a port number that is defined by default, or as a variant may have been recorded with the address @IP4-1 in the plurality of elements AD ASTRA-ELTS. The message B-M that is obtained, which here contains the payload data DATA destined for the recipient server 5, the IP address @IP5 of the recipient server 5 and its port number P5 (commonly referred to as transport address of the recipient server 5), and the padding pattern PATT, which are items of information that are all in encrypted form, is a scrambled message within the meaning of the invention containing data destined for the recipient server 5 but addressed to the relay node 4-1. Each scrambled message B-M obtained by the execution module 2C is then sent by the sending module 2D of the client device 2 to the relay node 4-1 (step E70).

It should be noted that FIG. 10 only partially shows the scrambled message B-M, and is provided only by way of illustration for better understanding of the invention. Of course, such a message comprises other elements, such as a source IP address and port number (which may also be encrypted), etc.

As a variant, as mentioned above, the scrambling instruction INST may comprise an instruction for the client device 2 to establish one or more fake connections to or via the relay node 4-1 to scramble the messages containing data destined for the recipient server 5 that are addressed to the relay node 4-1. According to this variant, the execution module 2C proceeds as described above: it inserts, into a message M, in encrypted form (encrypted by way of the encryption mechanism ENC2), an inner data packet I-PKT having, as its destination address, the address @IP5 of the recipient server 5, and comprising, in a form encrypted by way of the encryption mechanism ENC1, the payload data DATA destined for the recipient server 5 (no addition of any padding pattern unless the scrambling instruction INST also contains a padding instruction in addition to the instruction). The destination address of the message M is the transport address of the relay node comprising its IP address @IP4-1 and its port number P4-1.

The message M that is thus formed is sent to the relay node 4-1 by the sending module 2D of the client device 2 on the main connection established by the client device 2 to the relay node 4-1, in a manner known per se. In this variant embodiment, the execution module 2C of the client device 2 also establishes, in addition to the main connection used to address the message M to the relay node 4-1, one or more other fake connections to the relay node 4-1 and/or via this relay node 4-1 to one or more dedicated servers, in accordance with the instruction INST. It sends, on these fake connections and at the same time as the sending of the message M on the main connection, messages F-M containing fake data, that is to say data that are not intended to be consumed or to be exploited strictly speaking by the relay node 4-1 and/or by the dedicated servers. These fake data are for example generated randomly by the execution module 2C.

The fake connections thus emulated by the execution module 2C are advantageously added to the main connection established between the client device 2 and the relay node 4-1. A malicious third-party entity is therefore not able to distinguish the message comprising payload data M destined for the recipient server 5 from the fake messages F-M sent simultaneously on the fake connections. The fake connections established by the client device 2 therefore, by way of the fake messages F-M sent to the relay node 4-1 or via the relay node 4-1 at the same time as the message M, “scramble” the message M (which is referred to below as scrambled message B-M as in the previous variant).

With reference to FIG. 8, the relay node 4-1 receives, via its reception module 4A, each scrambled message B-M sent by the client device 2 (step G10).

The node 4-1 decrypts each scrambled message B-M received, and then removes, via its processing module 4B, the scrambling introduced by the execution module 2C of the client device 2 (step G20). In the embodiment described here, the scrambling introduced by the client device 2 is padding of the inner data packets sent by the application APP by way of at least one padding pattern PATT provided in the instruction INST or generated using a generation technique recorded in this instruction. These one or more padding patterns PATT or the generation technique for generating them were moreover transmitted by the DNS server 3-1 to the relay node 4-1 in the notification step F80/step G00. Obtaining these one or more padding patterns PATT or the technique for generating them constitutes in itself a step of acquiring information relating to the scrambling instruction INST applied by the client device 2 within the meaning of the invention.

It is of course possible to envisage other ways for the relay node 4-1 to acquire information representative of the scrambling instruction INST applied by the client device 2. For example, the scrambling pattern may be indicated explicitly by the client device in the scrambled packet itself, as mentioned above.

Thus, in the embodiment described here, removing the scrambling introduced by the execution module 2C of the client device 2 consists, for the processing module 4B, in removing the padding bits/symbols corresponding to the one or more padding patterns PATT that it has received from the DNS server 3-1 or generated using the generation technique received from the DNS server 3-1. It thus obtains the inner data packets I-PKT destined for the recipient server 5.

In the variant in which the scrambling instruction INST comprises an instruction to establish fake connections, the processing module 4B may locally terminate the fake connections established therewith (or relay the messages F-M to the one or more dedicated servers where applicable) and extract the inner data packet I-PKT from the message M received on the main connection after decryption of the packet.

As illustrated schematically in FIG. 11, the processing module 4B replaces, in each obtained inner data packet I-PKT, the source IP address and port number of the client device 2 (respectively denoted @IP2 and P2 in the figure) at the origin of the inner data packet I-PKT with its external IP address and its external source port number (or any other identifier used by the transport protocol, such as for example the identifiers int-VTag or rem-VTag for the SCTP protocol), respectively denoted @IP4-1_e and P4-1_e. It stores the source port number P2 and the source IP address @IP2 of the client device 2 in a local table in its non-volatile memory NVM. It then transfers the obtained data packet to the recipient server 5, in a manner known per se (step G30). For simplification, it will be considered here that the obtained data packet is transferred directly to the recipient server 5 (without any intermediary between the relay node 4-1 and the recipient server 5). However, this hypothesis is not limiting per se, and the invention is also applicable to the transfer of the data packet to the recipient server 5 via one or more other relay nodes.

Similarly, for simplification, the same port number P2 has been considered here for the client device for the message B-M and for the inner data packet I-PKT. However, different port numbers may be used by the client device 2.

In one particular embodiment, the relay node 4-1 adds scrambling before transferring the data packet I-PKT to the recipient server 5. For this purpose, as described above for the client device 2, it may in particular establish fake connections to dedicated servers, or to other (“actual”) servers. This scrambling introduced between the relay node 4-1 and the recipient server 5 is particularly advantageous, particularly when the number of client devices using one and the same relay node 4 is less than a given threshold.

It will be assumed here that the recipient server 5 responds to at least one of the data packets I-PKT received from the client device 2 via the relay node 4-1 by way of what is referred to as a “return” data packet denoted R-PKT, the payload data contained in this return packet being encrypted according to the needs of the service S by way of the encryption mechanism ENC1.

In accordance with the source port number and IP address indicated in the inner data packets I-PKT received from the relay node 4-1, the return data packet R-PKT is sent by the recipient server 5 to the relay node 4-1. Upon receipt of this return packet R-PKT by the relay node 4-1 (step G40), the processing module 4C replaces its external port number P4-1_e and its external IP address @IP4-1_e in the destination address of the return data packet R-PKT with the port number P2 and the IP address @IP2 of the client device 2. Moreover, it scrambles the return data packet R-PKT thus modified by applying to it, here, the same type of scrambling as that applied by the client device 2 in accordance with the scrambling instruction INST. In the example envisaged here, the processing module 4C thus applies the one or more scrambling patterns PATT, notified by the DNS server 3-1 in steps F80/G00 (or generated using the generation technique provided by the DNS server 3-1) (step G50), and then encrypts the obtained scrambled return data packet in its entirety (that is to say including its headers) in accordance with the encryption scheme ENC2 used between the relay node 4-1 and the client device 2. The processing module 4C inserts the encrypted scrambled return data packet thus obtained into a return message whose destination address is the IP address of the client device 2 (extracted from the local table of the relay node 4-1). The obtained scrambled return message B-MR is then transferred by the relay node 4-1 to the client device 2 (step G60).

In one variant embodiment (not illustrated in FIG. 11), the processing module 4C also replaces, in the return data packet R-PKT, the source port number P5 and IP address @IP5 of the recipient server 5 with its port number P4-1 and its IP address @IP4-1 (which may be said to be “internal” with respect to the visible external port number P4-1_e and IP address @4-1_e of the recipient server 5), before scrambling and encrypting it.

Upon receipt of the scrambled return message B-MR by the client device 2 (step E80), the latter decrypts it and then removes the scrambling introduced by the relay node 4-1 (by removing the bits/symbols added in accordance with the one or more padding patterns PATT) and accesses the return data packet R-PKT sent by the recipient server 5 (step E90).

Of course, other inner and return data packets may be exchanged in a similar or identical manner between the client device 2 and the recipient server 5 via the relay node 4-1 or via another relay node 4 designated by the DNS server 3-1 for the client device 2 and the recipient server 5 and supplied in the “relay-locators” parameter of the response REP-DNS.

It will now be assumed that a new name resolution request REQ′-DNS is sent as part of the client device 2 accessing the service S, and that this new request REQ′-DNS is correlated with the request REQ-DNS that was sent previously (for example, it relates to the resolution of the name of a subdomain of the domain to which the request REQ-DNS relates).

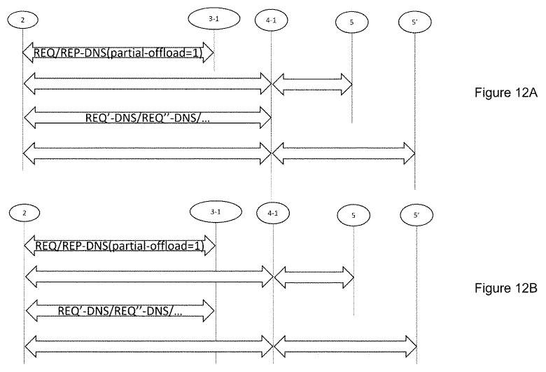

If the client device 2 supports the partial-offload function (“partial-offload” parameter set to 1 in the request REQ-DNS), and if the DNS server 3-1 has indicated the relay node 4-1 in the “partial-offload” parameter of its response REQ-DNS, then the client device 2 addresses the new request REQ′-DNS directly to the relay node 4-1, as illustrated in FIG. 12A. The same applies for all subsequent name resolution queries (REQ″-DNS, etc.) connected to the request REQ-DNS. It should be noted that the resolution of subsequent queries may result in a recipient server 5′different from the recipient server 5, as illustrated in FIG. 12A.

If the client device 2 does not support the partial-offload function (“partial-offload” parameter set to 0 in the request REQ-DNS), the client device 2 continues to use the DNS server 3-1, as illustrated in FIG. 12B. The same applies if the new DNS request REQ′-DNS is not correlated with the request REQ-DNS, including when the client device 2 supports the partial-offload function.

In the embodiment described here, consideration has been given to DNS exchanges between the client device 2, the one or more DNS servers 3 and the relay nodes 4. However, the invention is applicable to any type of name to be resolved, regardless of format, and not only to a domain name as defined by document RFC 1034. Thus, everything that has been described above with reference to a domain name is applicable to the resolution of any name of an IP resource.

Although the present disclosure has been described with reference to one or more examples, workers skilled in the art will recognize that changes may be made in form and detail without departing from the scope of the disclosure and/or the appended claims.

1. A method for processing a first name resolution request from a client device, said method being implemented by a name resolution server and comprising:
sending, to said client device, a response to the first name resolution request comprising at least one item of information relating to a recipient server, resulting from resolution of said first name resolution request; and
sending, to said client device, a plurality of elements comprising:
at least one address of at least one relay node selected by the name resolution server to which the client device has to address all or some of its messages containing data destined for the recipient server; and
at least one scrambling instruction to be applied by the client device to said messages before addressing them to said at least one relay node.

2. The processing method as claimed in claim 1, wherein at least one said relay node selected by the name resolution server satisfies at least one of the following conditions:
preventing a correlation between said relay node and the recipient server; and/or
maximizing a number of client devices using said relay node; and/or
optimizing client devices using said relay node according to at least one given criterion; and/or
having a route from said relay node to the recipient server.

3. The processing method as claimed in claim 1, wherein said at least one scrambling instruction comprises a padding instruction to pad said messages before addressing them to said at least one relay node, said instruction comprising at least one padding pattern to be used by the client device to scramble said messages or a technique for generating at least one such padding pattern.

4. A communication method implemented by a client device, comprising:
receiving, from a name resolution server, a response to a first name resolution request sent by the client device, the response comprising at least one item of information relating to a recipient server, resulting from resolution of the first name resolution request;
receiving plurality of elements, from the name resolution server, comprising:
at least one address of at least one relay node selected by the name resolution server to which the client device has to address all or some of the client device's messages containing data destined for the recipient server; and
at least one scrambling instruction to be applied by the client device to said messages before addressing them to said at least one relay node;
applying said at least one scrambling instruction to said messages.

5. The communication method as claimed in claim 4, wherein said at least one scrambling instruction comprises a padding instruction to pad said messages, and applying of said at least one scrambling instruction comprises padding at least one said message using a padding pattern provided in said padding instruction or generated by way of a generation technique provided in said padding instruction.

6. The communication method as claimed in claim 4, wherein said at least one scrambling instruction comprises an instruction to establish at least one fake connection to and/or via said at least one relay node.

7. The method as claimed in claim 1, wherein said messages addressed to said at least one relay node comprise, in encrypted form, data destined for the recipient server and an address of said recipient server.

8. The method as claimed in claim 1, wherein said plurality of elements furthermore comprises a first indication that at least one said relay node may be used by said client device to send at least one second name resolution request correlated with the first name resolution request.

9. The method as claimed in claim 8, wherein said plurality of elements furthermore comprises a second indication identifying name resolution requests that the first indication concerns.

10. The method as claimed in claim 1, wherein said plurality of elements furthermore comprises at least one identifier of said at least one relay node selected by the name resolution server.

11. The method as claimed in claim 1, wherein the first name resolution request comprises at least one identifier of at least one relay node previously selected for the client device and to which the client device addresses all or some of the client device's messages comprising data destined for the recipient server.

12. The method as claimed in claim 11, wherein at least one said relay node selected by the name resolution server coincides with a relay node identified in the first name resolution request.

13. The method as claimed in claim 1, wherein all or some of said plurality of elements is sent to the client device or received by the client device in said response to the first name resolution request.

14. The method as claimed in claim 1, furthermore comprising notifying said at least one relay node of at least one item of information relating to said at least one scrambling instruction.

15. A method for processing messages implemented by a relay node selected by a name resolution server for a client device and a as recipient server, said method comprising:
acquiring at least one item of information relating to at least one scrambling instruction applied by the client device to messages comprising data destined for the recipient server before addressing the messages to the relay node;
upon receipt of at least one scrambled message comprising data destined for the recipient server and addressed to the relay node by the client device, removing the scrambling applied by the client device using said acquired at least one item of information; and
transferring said at least one message obtained after removal of the scrambling to the recipient server.

16. The method as claimed in claim 15, furthermore comprising, upon receipt of at least one message from the recipient server and comprising data destined for the client device, scrambling said at least one message before transferring the at least one message to the client device.

17. A name resolution server comprising:
at least one processor; and
at least one non-transitory computer readable medium comprising instructions stored thereon which when executed by the at least one processor configure the name resolution server to send a response to a first name resolution request from a client device, said response comprising at least one item of information relating to a recipient server, resulting from resolution of said first name resolution request, and to send, to said client device, a plurality of elements comprising:
at least one address of at least one relay node selected by the name resolution server to which the client device has to address all or some of the client device's messages comprising data destined for the recipient server; and
at least one scrambling instruction to be applied by the client device to said messages before addressing them to said at least one relay node.

18. A client device at least one processor; and at least one non-transitory computer readable medium comprising instructions stored thereon which when executed by the at least one processor configure the client device to:
receive, from a name resolution server, a response to a first name resolution request sent by the client device, the response comprising at least one item of information relating to a recipient server, resulting from resolution of the first name resolution request;
receive a plurality of elements, from the name resolution server, comprising:
at least one address of at least one relay node selected by the name resolution server to which the client device has to address all or some of the client device's messages comprising data destined for the recipient server; and
at least one scrambling instruction to be applied by the client device to said messages addressed to said at least one relay node;
apply said scrambling instruction to said messages.

19. A relay node which is connectable in a communications network selected by a name resolution server for a client device and a recipient server, said relay node comprising:
at least one processor; and
at least one non-transitory computer readable medium comprising instructions stored thereon which when executed by the at least one processor configure the relay node to
acquire at least one item of information relating to at least one scrambling instruction applied by the client device to messages comprising data destined for the recipient server before addressing them to the relay node;
upon receipt of at least one scrambled message comprising data destined for the recipient server and addressed to the relay node by the client device, remove the scrambling applied by the client device using said acquired at least one item of information; and
transfer said at least one message obtained after removal of the scrambling to the recipient server.

20. (canceled)
